(19) United States
(12) Patent Application Publication
(10) Pub. No.: US 2022/0309568 A1
(43) Pub. Date: Sep. 29, 2022

(54) DRIVING FORCE SHARING SYSTEM

(71) Applicant: HONDA MOTOR CO., LTD., Tokyo (JP)

(72) Inventor: Ryoma HAMASUNA, Saitama (JP)

(21) Appl. No.: 17/668,386

(22) Filed: Feb. 10, 2022

(30) Foreign Application Priority Data
Mar. 26, 2021 (JP) 2021-052867

(51) Int. Cl. G06Q 30/06; G06Q 50/30

(52) U.S. Cl. CPC G06Q 30/0645; G06Q 50/30

(57) ABSTRACT

Provided is a system enabling rental of an appropriate movable body for realizing a necessary operation according to a purpose of a user. A server 200 selects a movable body suitable for purpose of a user by: obtaining purpose information from a user terminal 100; calculating a necessary output on the basis of the purpose information; and performing matching between the necessary output and output information of a rentable rental movable body 300.

This application is based on and claims the benefit of priority from Japanese Patent Application No. 2021-052867, filed on 26 Mar. 2021, the content of which is incorporated herein by reference.

### BACKGROUND OF THE INVENTION

### Field of the Invention

The present invention relates to a system for sharing driving force.

### Related Art

In recent years, a car-sharing system allowing a plurality of users to use a vehicle in a shared manner is becoming popular. The car-sharing system means a system in which a user becomes a member of a car-sharing operator without possessing a vehicle, to use vehicles possessed by the operator when necessary. In the car-sharing system, since a vehicle is shared by a plurality of users, use at a low cost and convenient use are enabled, possibly increasing demand for use of vehicles.

Patent Document 1 discloses employing a pricing system in which a first rate lower than a standard rate is applied as a usage fee when an SOC (State of Charge) at the time of renting is within a recommended range and the SOC at the time of returning is also within the recommended range, to promote suppression of deterioration of a secondary battery, provided that the “recommended range” refers to a range of a power storage amount (e.g., 30% to 70%) in which a power storage device can be used while suppressing deterioration of the secondary battery included therein.
Patent Document 1: Japanese Unexamined Patent Application, Publication No. 2019-87041

### SUMMARY OF THE INVENTION

However, most of the conventional car-sharing systems are targeted at passenger vehicles. In regard to a tow truck, which tows an inhabitation vehicle for camping not provided with driving force and requires driving force of at least a certain value for towing, the “driving force no less than a certain value” varies by user and a system has not been proposed for sharing such a tow truck. In addition, a system has not been proposed either for arranging an additional tow truck in a case in which a user who has departed with a single tow truck, which was considered to be sufficient, encounters an unexpected mountain road with a steep slope.

An objective of the present invention is to provide a system enabling an appropriate movable body to be rented so that a user can achieve a necessary operation according to a purpose of the user.

The present inventors have found that selection of a movable body suitable for a purpose of a user is enabled by: obtaining purpose information from a user terminal; calculating a necessary output on the basis of the purpose information; and performing matching between the necessary output and output information of a rentable movable body, leading to completion of the present invention.

(1) In order to achieve the aforementioned objective, the present invention provides a driving force sharing system provided with a server that configures a movable body to be rented to a user, in which the server: obtains output information of a rentable movable body; obtains purpose information from a user terminal; calculates a necessary output on the basis of the purpose information; and selects the movable body to be rented on the basis of the necessary output.

The driving force sharing system of (1) enables a user to rent an appropriate movable body suitable for the purpose.

(2) In the driving force sharing system according to (1): the purpose information may include route information obtained from a renting location and a destination, and information of a tow object or a load weight; and the necessary output may include driving force calculated on the basis of the purpose information.

The driving force sharing system of (2) enables an appropriate output to be obtained according to the purpose of the user.

(3) In the driving force sharing system according to (1) or (2), the server, on the basis of the necessary output and the output information of a rentable movable body, may configure whether a first movable body capable of delivering an output greater than the necessary output is to be rented, or a plurality of second movable bodies, an output of which is lower than that of the first movable body, is to be rented.

The driving force sharing system of (3) enables efficient rental according to the output of the movable body.

(4) In the driving force sharing system according to (3), the server, in a case in which the output of the second movable body is smaller than an output obtained by adding a predetermined output to the necessary output, may rent the second movable body when an additional arrangement of a movable body is possible on a route, and may rent the first movable body when the additional arrangement of a movable body is not possible on the route.

The driving force sharing system of (4) prevents renting of a movable body with an unnecessarily great output, thus increasing efficiency.

(5) In the driving force sharing system according to (3), the server: may calculate a first fee for renting the first movable body singly and a second fee for renting a plurality of the second movable bodies; and may configure a rental pattern on the basis of the first fee and the second fee.

The driving force sharing system of (5) enables rental to the user based on an appropriate fee.

According to the present invention, a system enabling renting of an appropriate movable body for realizing a necessary operation according to a purpose of a user can be provided.

### BRIEF DESCRIPTION OF THE DRAWINGS

FIG. 1 is a diagram schematically showing a whole configuration of a driving force sharing system according to an embodiment of the present invention;

FIG. 2 is a sequence diagram of the driving force sharing system according to the embodiment of the present invention;

FIG. 3 is a sequence diagram of the driving force sharing system according to the embodiment of the present invention;

FIG. 4 is a sequence diagram of the driving force sharing system according to the embodiment of the present invention;

FIG. 5 is a diagram showing a logic of selection of a rental movable body of the driving force sharing system according to the embodiment of the present invention;

FIG. 6 is a diagram showing a logic of selection of a rental movable body of the driving force sharing system according to the embodiment of the present invention;

FIG. 7 is a diagram showing a logic of selection of a rental movable body of the driving force sharing system according to the embodiment of the present invention; and

FIG. 8 is a diagram showing a logic of selection of a rental movable body of the driving force sharing system according to the embodiment of the present invention.

### DETAILED DESCRIPTION OF THE INVENTION

### Embodiment

Hereinafter, an embodiment of the present invention will be described with reference to the drawings. However, the embodiment described below is an example of the embodiment, and the present invention is not limited thereto.

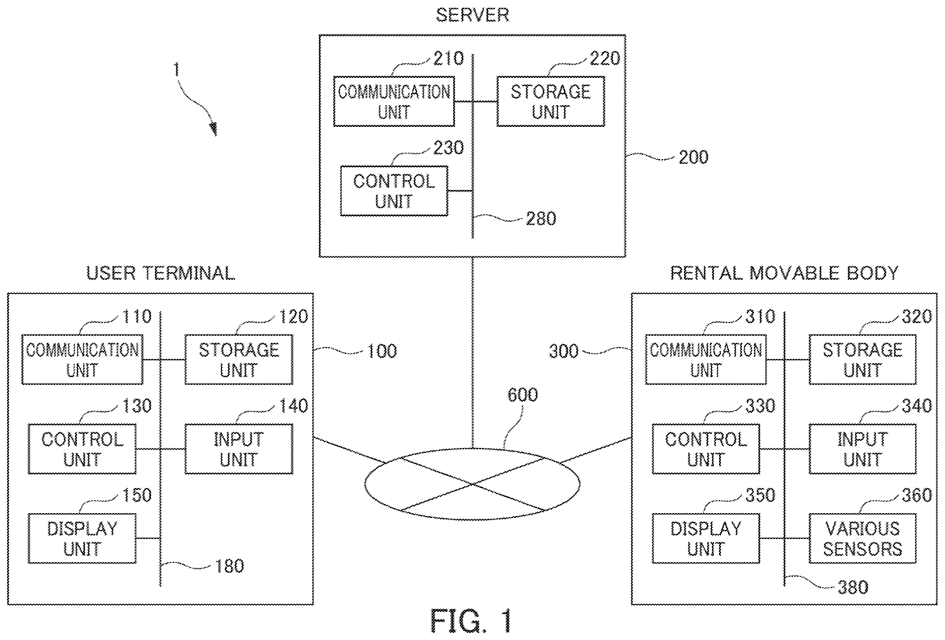

FIG. 1 is a diagram showing a whole configuration of a driving force sharing system 1 according to the present embodiment. The driving force sharing system 1 is provided with: a user terminal 100; a server 200; a rental movable body 300; and a communication network 600. The rental movable body 300 corresponds to the above-described tow truck provided with driving force. Typically, there are a plurality of rental movable bodies 300. The rental movable body 300 may be either a gasoline-powered vehicle powered to travel by an internal combustion engine, or an electric vehicle. An owner of the rental movable body 300 may be either the same as or different from an owner of the server 200.

The user terminal 100 is a terminal that a user who rents the rental movable body 300 possesses. The user terminal 100 is specifically a smartphone, a personal computer, or the like. The user terminal 100 is provided with a communication unit 110, a storage unit 120, a control unit 130, an input unit 140, and a display unit 150. These units are connected by a communication bus 180. The communication unit 110 is configured to be able to communicate with the server 200 via the communication network 600. The storage unit 120 includes a large-capacity storage device such as a flash memory, a hard disk, or the like.

The control unit 130 is provided with a CPU (Central Processing Unit) and a memory, and carries out various controls in the user terminal 100. The input unit 140 is an input device in the user terminal 100. Specifically, the input unit 140 is a keyboard, a mouse, a touch panel, and the like. The user uses the input unit 140 to input information as to for what purpose the rental movable body is to be used, and the like. The display unit 150 is configured with a liquid crystal panel and the like, and displays a message transmitted from the server 200.

The server 200: mediates the user terminal 100 and the rental movable body 300; performs matching between a request from the user terminal 100 and information of the rental movable body 300; and communicates a result of the matching to both of the user terminal 100 and the rental movable body 300. The server 200 is provided with a communication unit 210, a storage unit 220, and a control unit 230. These units are connected by a communication bus 280. The communication unit 210 is configured to be able to communicate with the user terminal 100 and the rental movable body 300 via the communication network 600.

The storage unit 220 includes a large-capacity storage device such as a hard disk, a solid-state drive, or the like. The control unit 230 is provided with a CPU and a memory, and performs a process of matching between the request from the user terminal 100 and information of the rental movable body 300.

The rental movable body 300 is a movable body which is possibly rented to the user. The rental movable body 300 is provided with a communication unit 310, a storage unit 320, a control unit 330, an input unit 340, a display unit 350, and various sensors 360. These units and the various sensors 360 are connected by a communication bus 380. The communication unit 310 is configured to be able to communicate with the server 200 via the communication network 600. The storage unit 320 includes a large-capacity storage device such as a flash memory, a hard disk, or the like. The control unit 330 is provided with a CPU and a memory, and carries out various controls in the rental movable body 300.

The input unit 340 is an input device in the rental movable body 300. Specifically, the input unit 340 is a keyboard, a mouse, a touch panel, and the like. The display unit 350 is configured with a liquid crystal panel and the like, and displays a message transmitted from the server 200.

The various sensors 360 are sensors for obtaining various measured values about the rental movable body 300. Specifically, first, a GPS (Global Positioning System) for obtaining a current location of the rental movable body 300 is provided. The control unit 330 determines whether the rental movable body 300 is on a planned travel route or out of the planned travel route, on the basis of the current location obtained by the GPS device. Next, various sensors for measuring a voltage, an electric current, and a temperature of a secondary battery are provided. The control unit 330 estimates an OCV (Open Circuit Voltage) on the basis of the measured values by these sensors, and calculates an SOC of the power storage device. Note that the control unit 330 may calculate the SOC of the power storage device on the basis of another method. In addition, the various sensors 360 may include a torque sensor for measuring driving force generated in the rental movable body 300. Furthermore, a sensor may also be provided for measuring an amount of fuel (hereinafter referred to as “fuel amount”) of the rental movable body 300 or electric power amount of the rental movable body 300.

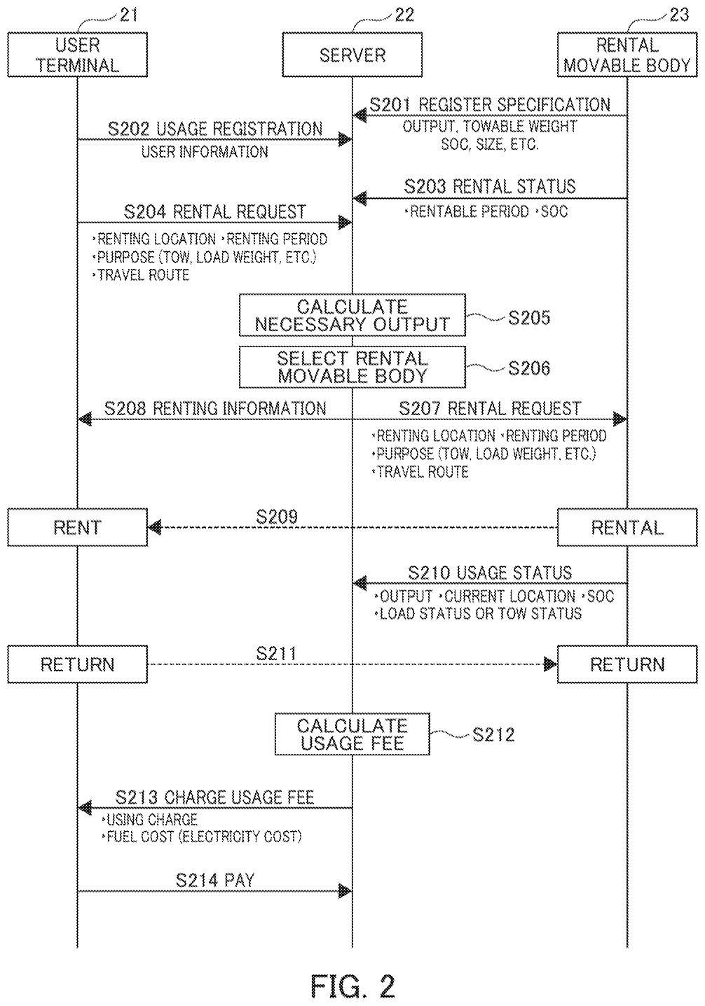

FIG. 2 is a sequence diagram of renting a rental movable body to the user. Step S201: The rental movable body 23 registers specification information to the server 22. The specification includes, for example: torque/electric power that the rental movable body 23 can output; weight that the rental movable body 23 can tow; the current SOC; the size of the rental movable body 23; and the like. In addition, an AC output (alternate current output) and a low-voltage output in the case of using the rental movable body 23 as a power source may be added to the specification. Furthermore, the fuel amount or the electric power amount of the rental movable body 23 may be added to the specification.

Step S202: The user uses the user terminal 21 to register user information to the server 22. Step S203: The rental movable body 23 registers a rentable period and the current SOC to the server 22.

Step S204: The user uses the user terminal 21 to register: a location where the user wishes to rent the rental movable body 23; a period of renting the rental movable body 23; a purpose (weight to tow, loaded weight); a travel route; and the like. In addition, the AC output and the low-voltage output in the case of using the rental movable body 23 as a power source may be registered. Step S205: The server 22 calculates a necessary output (torque/electric power) on the basis of the purpose (weight to tow, loaded weight) transmitted from the user terminal 21. In addition, the server 22 calculates a necessary energy amount (fuel amount/electric power amount) on the basis of the purpose (weight to tow, loaded weight) transmitted from the user terminal 21, and the travel route.

Step S206: The server 22 performs matching on the basis of information of a rental request from the user terminal 21 and information of the specification registration from the rental movable body 23. The logic of this matching is explained later in detail in the section <Logic of Selection of Rental Movable Body>. Step S207: The server 22 transmits to the matched rental movable body 23 information of: a renting location; a renting period; a purpose (weight to tow, loaded weight); and a travel route.

Step S208: The server 22 transmits to the matched user terminal 21 of the user, information regarding the rental movable body 23 determined to be rented. Step S209: The user rents the rental movable body 23. Step S210: While the user uses the rental movable body 23, the rental movable body 23 periodically transmits the usage status to the server 22. The usage status is exemplified by the output (torque/electric power), the current location, the SOC, the load status or the tow status, and the like.

Step S211: When the user finishes using the rental movable body 23, the user returns the rental movable body 23. Step S212: The server 22 calculates the usage fee. Step S213: The server 22 charges the user the usage fee. The usage fee consists of a using charge for using the driving force sharing system, and an actual cost portion corresponding to a cost of the fuel or electricity consumed. Step S214: The user pays the usage fee.

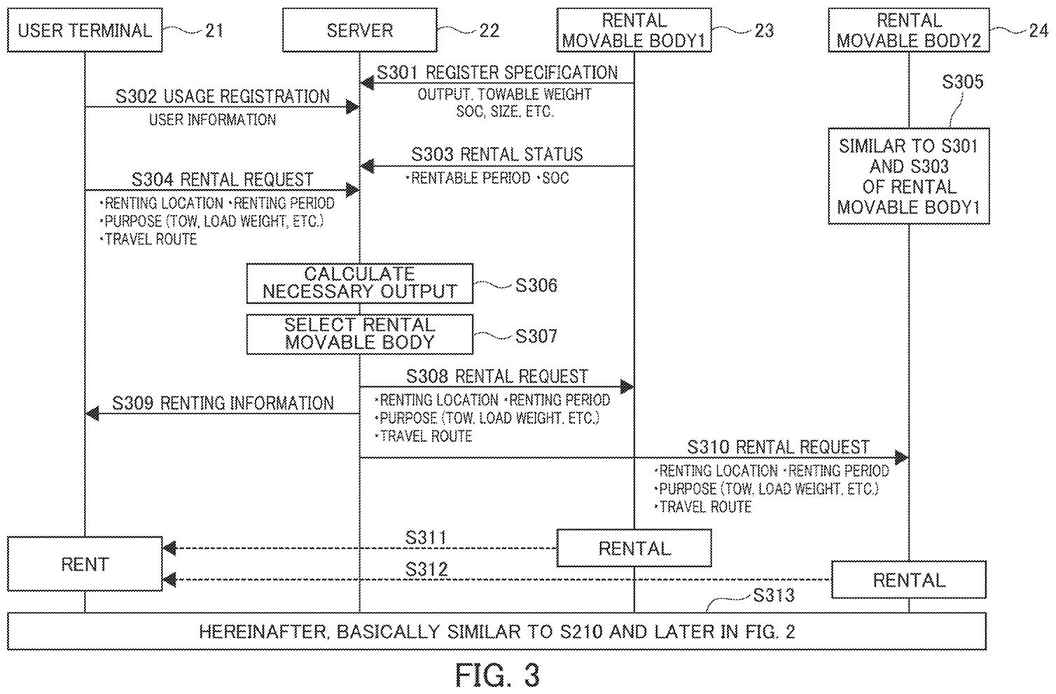

FIG. 2 shows a case in which one rental movable body has been determined as a result of selection of the rental movable body in Step S206. However, in practice, in light of a relationship between the output of the rental movable body and the tow weight of the user, there may be a case in which a single rental movable body is not sufficient and two or more rental movable bodies are required. FIG. 3 shows a case in which two or more rental movable bodies are required. Since Steps S301 to S304 are identical to Steps S201 to S204, the description thereof is omitted. Then in S305, the rental movable body 2 also registers specification information and reports a rental status to the server 22 in a similar manner to Steps S301 and S303.

Step S306: The server 22 calculates a necessary output (torque/electric power) and a necessary energy amount (fuel amount/electric power amount). Step S307; The server 22 performs matching. As a result, it turns out that the rental movable body 1 is not sufficient to satisfy the request from the user and it is necessary to rent the rental movable body 2 as well. Step S308: The server 22 requests rental to the rental movable body 1. Step S309: The server 22 transmits renting information to the user terminal 21. Step S310: The server 22 requests rental to the rental movable body 2.

Step S311: The rental movable body 1 is rented. Step S312: The rental movable body 2 is rented. Step S313: Identical to Steps S210 and later in FIG. 2.

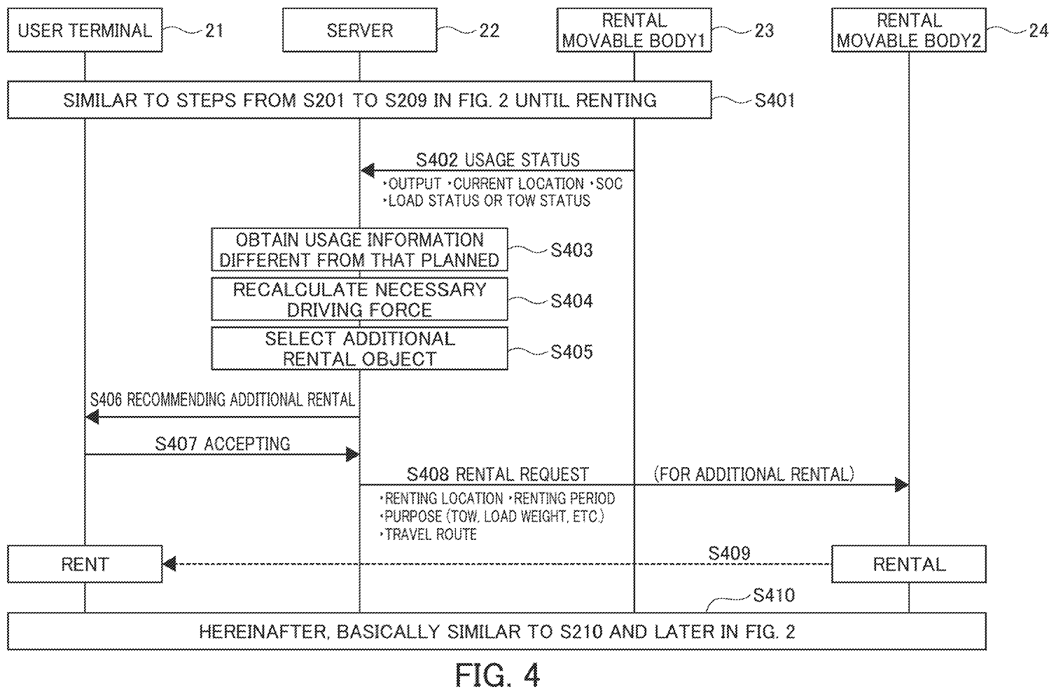

FIG. 3 shows a case in which it turns out in the phase of selecting the rental movable body in Step S307 that two rental movable bodies are necessary. However, in practice, there is a case in which two rental movable bodies are required for the reason that the travel route is altered on the way, a slope is unexpectedly steep, or the like, despite the initial estimate that one rental movable body is sufficient. FIG. 4 shows such a case in which two rental movable bodies are required on the way.

Suppose that the process of Steps S201 to S209 in FIG. 2 has been carried out in Step S401 in FIG. 4. Step S402: While the user uses the rental movable body 23, the rental movable body 1 periodically transmits the usage status to the server 22. The usage status is exemplified by the output (torque/electric power), the current location, the SOC, the load status or the tow status, and the like. Step S403: The server 22 obtains purpose information which is different from that planned, on the basis of the usage status from the rental movable body 1. For example, it is detected that the current location of the rental movable body 1 is in a steep mountain road, despite the planned travel route being flat. Alternatively, it is detected that the current output (torque/electric power) of the rental movable body 1 is equal or greater than the necessary output (torque/electric power) initially calculated.

Step S404: In such a case, the server 22 recalculates the necessary driving force. Step S405: The server 22 selects the rental movable body 2 to be additionally rented. Step S406: The server 22 recommends to the user the rental movable body 2 to be additionally rented. Step S407: The user accepts additionally renting the rental movable body 2 and transmits that effect to the server 22.

Step S408: The server 22 requests an additional rental of the rental movable body 2. Step S409: The user rents the rental movable body 2. Since Steps S410 and later are similar to Steps S210 and later in FIG. 2, the description thereof is omitted.

### <Logic of Selection of Rental Movable Body>

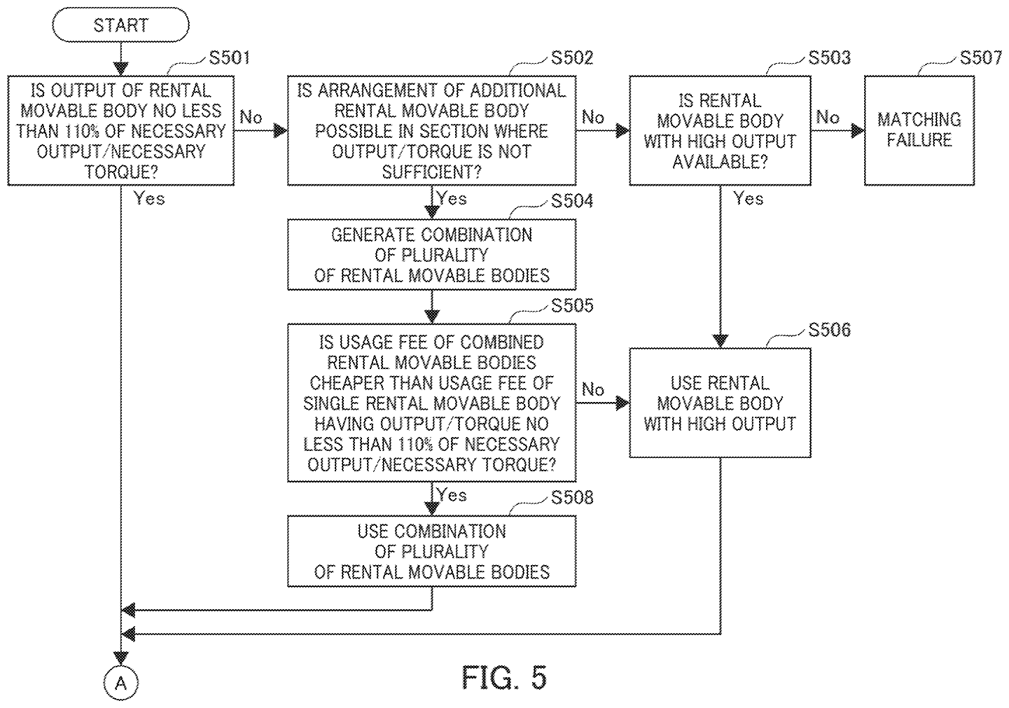

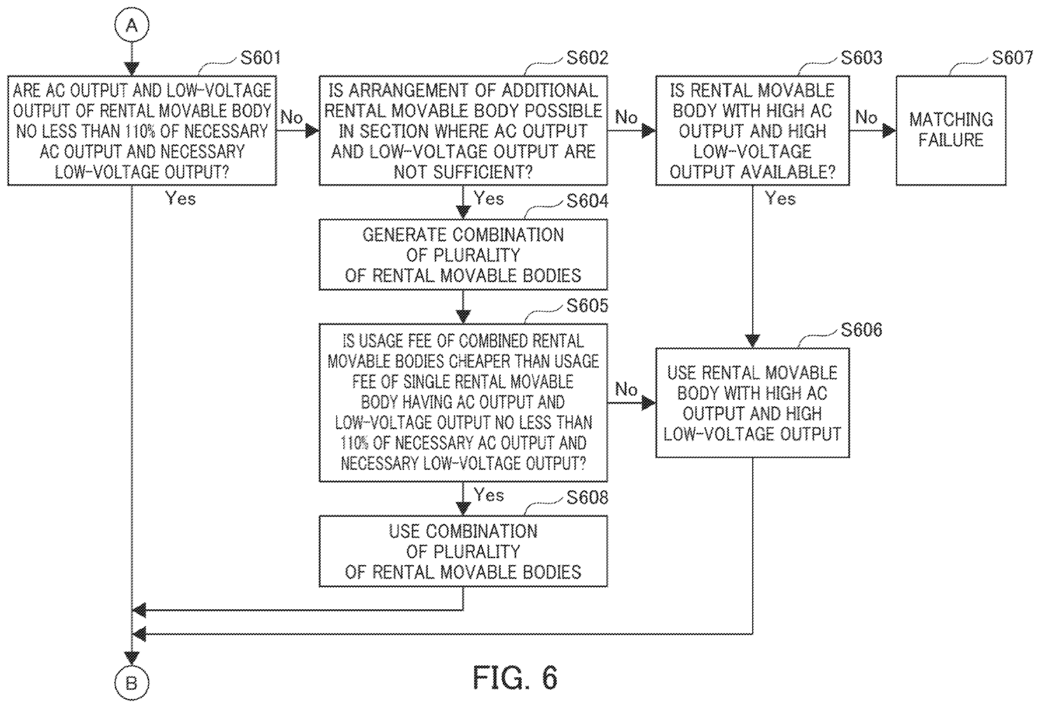

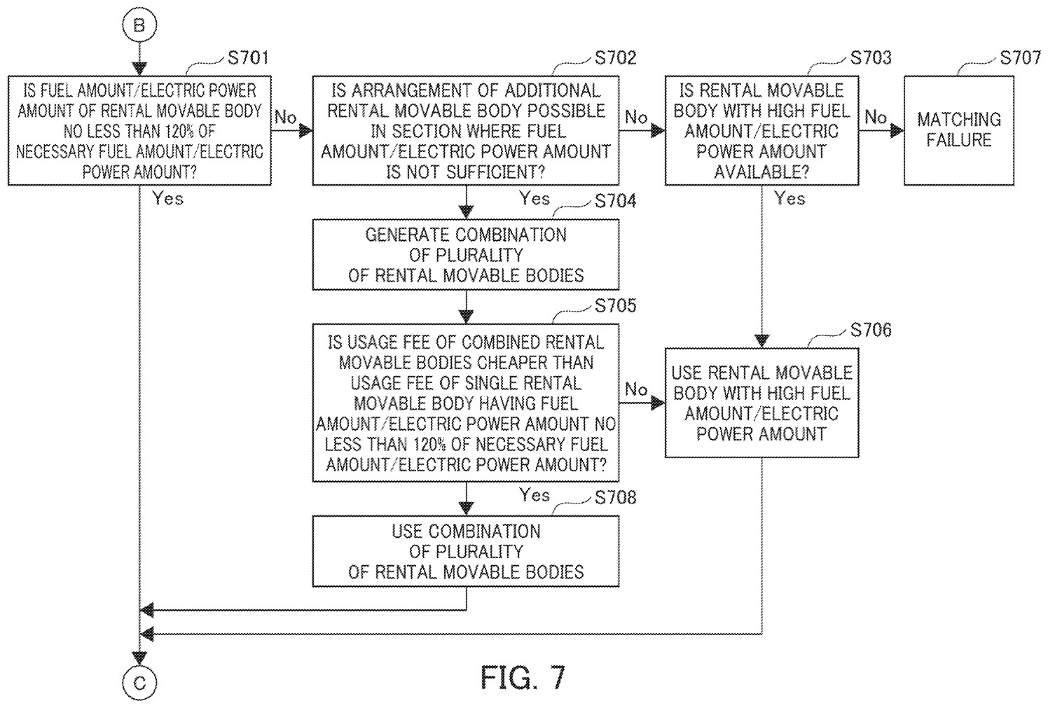

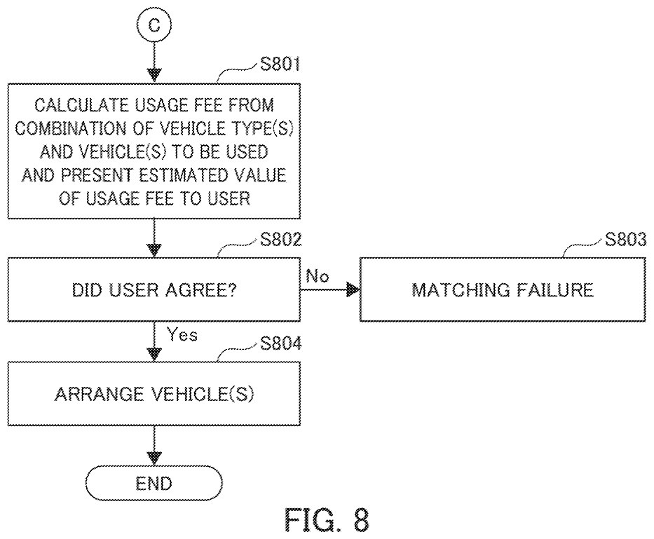

The logic of selection of a rental movable body will be described with reference to FIGS. 5 to 8. The information of the rental request transmitted from the user terminal 21 and the information of the specification of the rental movable body 23 transmitted from the rental movable body 23 are used for the selection. Step S501: The output of the rental movable body 23 is compared with the necessary output (torque/electric power) calculated from the purpose of the rental request (weight to tow, loaded weight). When the output of the rental movable body 23 is no less than 110% of the necessary output, the processing advances to “A”. When the output of the rental movable body 23 is less than 110% of the necessary output, the processing advances to Step S502.

Step S502: It is determined whether an additional rental movable body can be arranged in a section where the output of the rental movable body 23 is not sufficient. When an additional rental movable body can be arranged, the processing advances to Step S504. When an additional rental movable body cannot be arranged, the processing advances to Step S503. Step S503: It is determined whether a rental movable body having an output no less than 110% of the necessary output is available. When such a rental movable body is available, the processing advances to Step S506. When such a rental movable body is not available, the processing advances to Step S507 and terminates with a matching failure. Step S504: A combination of a plurality of rental movable bodies is generated. Then, the processing advances to Step S505.

Step S505: A usage fee of the combination of the plurality of rental movable bodies is compared with a usage fee of the single rental movable body having an output no less than 110% of the necessary output. When the usage fee of the combination of the plurality of rental movable bodies is cheaper, the processing advances to Step 3508. When the usage fee of the single rental movable body having an output no less than 110% of the necessary output is cheaper, the processing advances to Step S506.

Step S506: The single rental movable body having an output no less than 11.0% of the necessary output is selected and the processing advances to “A”. Step S508: The combination of the plurality of rental movable bodies is selected and the processing advances to “A”.

Step S601: The AC output and the low-voltage output of the rental movable body 23 are respectively compared with the necessary AC output and the necessary low-voltage output obtained from the rental request. When the AC output and the low-voltage output of the rental movable body 23 are no less than 110% of the necessary AC output and the necessary low-voltage output, respectively, the processing advances to “B”. When the AC output and the low-voltage output of the rental movable body 23 are less than 110% of the necessary AC output and the necessary low-voltage output, respectively, the processing advances to Step S602. Step S602: It is determined whether an additional rental movable body can be arranged in a section where the AC output and the low-voltage output of the rental movable body 23 are not sufficient. When an additional rental movable body can be arranged, the processing advances to Step S604. When an additional rental movable body cannot be arranged, the processing advances to Step S603.

Step S603: It is determined whether a rental movable body having an AC output and a low-voltage output no less than 110% of the necessary AC output and the necessary low-voltage output, respectively, is available. When such a rental movable body is available, the processing advances to Step S606. When such a rental movable body is not available, the processing advances to Step S607 and terminates with a matching failure. Step S604: A combination of a plurality of rental movable bodies is generated. Then, the processing advances to Step S605.

Step S605: A usage fee of the combination of the plurality of rental movable bodies is compared with a usage fee of the single rental movable body having an AC output and a low-voltage output no less than 110% of the necessary AC output and the necessary low-voltage output, respectively. When the usage fee of the combination of the plurality of rental movable bodies is cheaper, the processing advances to Step S608. When the usage fee of the single rental movable body having an AC output and low-voltage output no less than 110% of the necessary AC output and low-voltage output is cheaper, the processing advances to Step S606.

Step S606: The single rental movable body having an AC output and low-voltage output no less than 110% of the necessary AC output and low-voltage output is selected and the processing advances to “B”. Step S608: The combination of the plurality of rental movable bodies is selected and the processing advances to “B”.

Step S701: The fuel amount/electric power amount of the rental movable body 23 is compared with the necessary fuel amount/electric power amount calculated from the purpose of the rental request (weight to tow, loaded weight) and the travel route. When the fuel amount/electric power amount of the rental movable body 23 is no less than 120% of the necessary fuel amount/electric power amount, the processing advances to “C”. When the fuel amount/electric power amount of the rental movable body 23 is less than 120% of the necessary fuel amount/electric power amount, the processing advances to Step S702. Step S702: It is determined whether an additional rental movable body can be arranged in a section where the fuel amount/electric power amount of the rental movable body 23 is not sufficient. When an additional rental movable body can be arranged, the processing advances to Step S704. When an additional rental movable body cannot be arranged, the processing advances to Step S703.

Step S703: It is determined whether a rental movable body having a fuel amount/electric power amount no less than 120% of the necessary fuel amount/electric power amount is available. When such a rental movable body is available, the processing advances to Step S706. When such a rental movable body is not available, the processing advances to Step S707 and terminates with a matching failure. Step S704: A combination of a plurality of rental movable bodies is generated. Then, the processing advances to Step S705.

Step S705: A usage fee of the combination of the plurality of rental movable bodies is compared with a usage fee of the single rental movable body having a fuel amount/electric power amount no less than 120% of the necessary fuel amount/electric power amount. When the usage fee of the combination of the plurality of rental movable bodies is cheaper, the processing advances to Step S708. When the usage fee of the single rental movable body having a fuel amount/electric power amount no less than 120% of the necessary fuel amount/electric power amount is cheaper, the processing advances to Step S706.

Step S706: The single rental movable body having a fuel amount/electric power amount no less than 120% of the necessary fuel amount/electric power amount is selected and the processing advances to “C”. Step S708: The combination of the plurality of rental movable bodies is selected and the processing advances to “C”.

Step S801: The usage fee is calculated on the basis of the combination of vehicle type(s) and the vehicle(s) to be used. The estimate of the usage fee is presented to the user. Then, the processing advances to Step S802. Step S802: When the user did not agree, the processing advances to Step S803 and terminates with a matching failure. When the user agreed, the processing advances to Step S804. Step S804: The vehicle(s) is(are) arranged and the processing terminates.

The threshold values 110% and 120% indicated in the embodiment are merely examples. Naturally, other threshold values may be employed.

In the logic of selection of a rental movable body, the steps of checking the AC output and the low-voltage output may be omitted. In other words, Steps S601 to S608 may be omitted. In addition, the steps of checking the fuel amount/electric power amount may be omitted. In other words, Steps S701 to S708 may be omitted. Furthermore, both of Steps S601 to S608 and Steps S701 to S708 may be omitted.

In S214 in the embodiment, the owner of the rental movable body 300 is the owner of the server, and the user pays the usage fee to the owner of the server; however, when the owner of the rental movable body is someone different from the owner of the server, such as another user, it may also be configured that the usage fee from the user, who is a renter, and an incentive are paid to the owner of the rental movable body via the server.

In addition to an inhabitation vehicle for camping not provided with driving force, the vehicle to be towed is assumed to be, but not limited to, a passenger vehicle of a driver who had departed by car with no intention of consuming alcohol but consumed alcohol on the way, a waste collection vehicle, an agricultural vehicle, and the like.

The usage fee may also be a sum of a commission charge of the system and a using charge set to each rental movable body. The using charge set to each rental movable body may be proportional to a value obtained by multiplying the driving force with a usage period. When the plurality of rental movable bodies is rented, the driving force is a sum of driving forces of the rental movable bodies. In addition, in a case in which, before returning the rental movable body after use, the user refills the movable body past the fuel level or the charged level prior to the rental, an amount corresponding to a difference in level may be deducted from the using charge.

The present invention is not limited to the embodiment, and all modifications and improvements within a scope in which the objective of the present invention can be attained are encompassed in the present invention.

### EXPLANATION OF REFERENCE NUMERALS

1 Driving force sharing system
21 User terminal
22 Server
23 Rental movable body 1
24 Rental movable body 2
100 User terminal
110 Communication unit
120 Storage unit
130 Control unit
140 Input unit
150 Display unit
180 Communication bus
200 Server
210 Communication unit
220 Storage unit
280 Communication bus
300 Rental movable body
310 Communication unit
320 Storage unit
330 Control unit
340 Input unit
350 Display unit
360 Various sensors
360 Communication bus
600 Communication network

What is claimed is:

1. A driving force sharing system comprising a server that configures a movable body to be rented to a user, wherein
the server: obtains output information of a rentable movable body;
obtains purpose information from a user terminal;
calculates a necessary output on the basis of the purpose information; and
selects the movable body to be rented on the basis of the necessary output.

2. The driving force sharing system according to claim 1, wherein:
the purpose information includes
route information obtained from a renting location and a destination, and
information of a tow object or a load weight; and
the necessary output includes driving force calculated on the basis of the purpose information.

3. The driving force sharing system according to claim 1, wherein the server,
on the basis of the necessary output and the output information of a rentable movable body,
configures whether a first movable body capable of delivering an output greater than the necessary output is to be rented,
or a plurality of second movable bodies, an output of which is lower than that of the first movable body, is to be rented.

4. The driving force sharing system according to claim 3, wherein the server,
in a case in which the output of the second movable body is smaller than an output obtained by adding a predetermined output to the necessary output,
rents the second movable body when an additional arrangement of a movable body is possible on a route, and
rents the first movable body when the additional arrangement of a movable body is not possible on the route.

5. The driving force sharing system according to claim 3, wherein the server:
calculates a first fee for renting the first movable body singly and a second fee for renting a plurality of the second movable bodies; and
configures a rental pattern on the basis of the first fee and the second fee.
